(19) United States
(12) Patent Application Publication
(10) Pub. No.: US 2016/0241110 A1
(43) Pub. Date: Aug. 18, 2016

(54) ELECTRICAL BOOSTING DEVICE

(71) Applicant: BORGWARNER INC., Auburn Hills, MI (US)

(72) Inventors: Joel M. MAGUIRE, Northville, MI (US); Thomas A. GRISSOM, Dexter, MI (US); Kristoffer NILSSON, Lund (SE); Philip J. MOTT, Dryden, NY (US); Gerd BRAEUCHLE, Huffenhardt (DE)

(21) Appl. No.: 15/027,544

(22) PCT Filed: Oct. 7, 2014
(86) PCT No.: PCT/US2014/059439

§ 371 Date: Apr. 6, 2016

Related U.S. Application Data
(60) Provisional application No. 61/890,612, filed on Oct. 14, 2013.

(51) Int. Cl. H02K 7/18; H02K 5/20; H02K 9/19; H02K 11/33; F02B 33/36; B60L 7/10; H02K 16/00; F02B 39/10; F02B 33/40; H02K 5/04; F02N 11/08

(52) U.S. Cl. CPC H02K 7/1815; H02K 5/04; H02K 5/20; H02K 9/19; H02K 11/33; F02N 11/0814; B60L 7/10; H02K 16/00; F02B 39/10; F02B 33/40; F02B 33/36

(57) ABSTRACT

A number of variations may include a product comprising: an electric motor generator, a first power electronics module operatively connected to the electric motor generator; an electric motor constructed and arranged for driving an air delivery device, and a second power electronics module coupled to the electric motor. A number of variations may include a product comprising: an electric motor generator for a vehicle and an electric motor constructed and arranged for driving an air delivery device, and single housing enclosing the electric motor generator and an electric motor.

### CROSS-REFERENCE TO RELATED APPLICATIONS

This application claims the benefit of U.S. Provisional Application No. 61/890,612 filed Oct. 14, 2013.

### TECHNICAL FIELD

The field to which the disclosure generally relates to includes combustion engine boosts device systems and methods of using the same.

### BACKGROUND

Devices may be utilized to boost the air intake of a combustion engine.

### SUMMARY OF ILLUSTRATIVE VARIATIONS

A number of variations may include a product comprising: an electric motor generator, a first power electronics module operatively connected to the electric motor generator; an electric motor constructed and arranged for driving an air delivery device, and a second power electronics module coupled to the electric motor.

A number of variations may include a product comprising: an electric motor generator for a vehicle and an electric motor constructed and arranged for driving an air delivery device, and single housing enclosing the electric motor generator and an electric motor.

Other illustrative variations within the scope of the invention will become apparent from the detailed description provided hereinafter. It should be understood that the detailed description and specific examples, while disclosing variations within the scope of the invention, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 illustrates a boost system according to a number of variations.

### DETAILED DESCRIPTION OF ILLUSTRATIVE VARIATIONS

The following description of the variations is merely illustrative in nature and is in no way intended to limit the scope of the invention, its application, or uses.

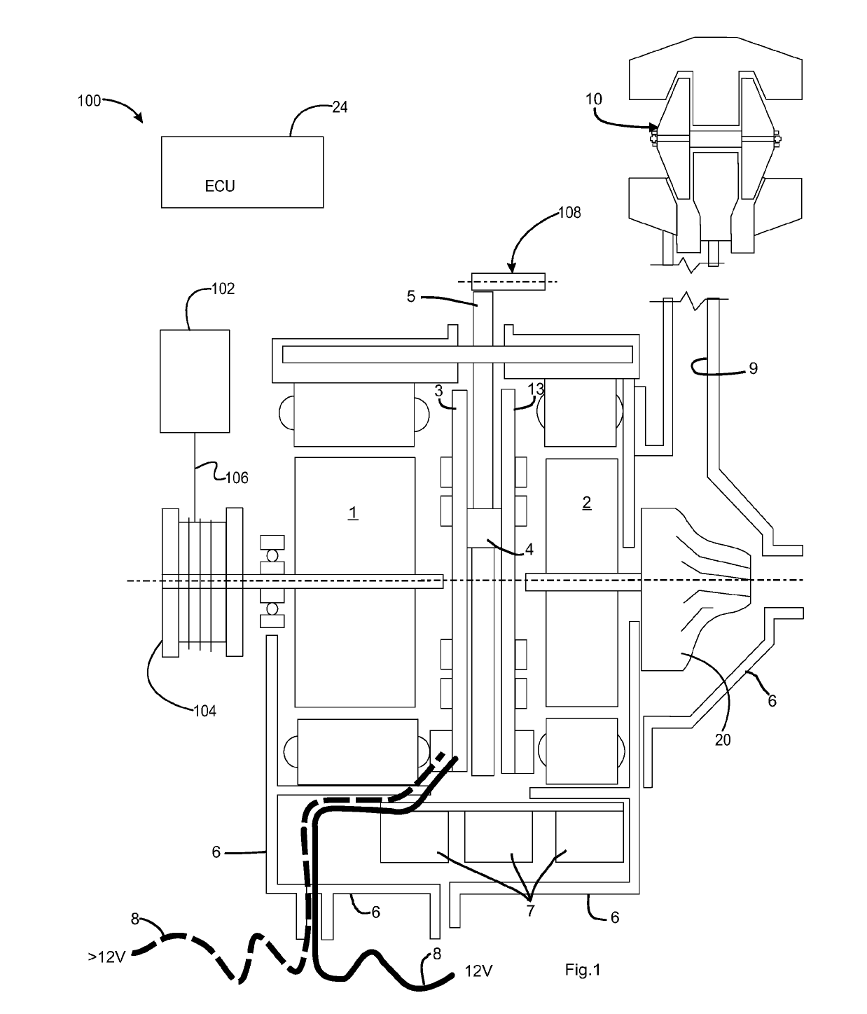

Referring now to FIG. 1, a product 100 according to a number of variations may include electric motor generator 1 (MG1) that may be connected to a combustion engine 102, for example but not limited to, an engine crank via a belt 106 or other structure for turning the electric motor generator 1. The combustion engine may be a gasoline, mixed fuel, diesel or an alternative combustible fuel engine. An electric motor 2 (M2) may be connected to an air delivery device 20, which may be constructed and arranged to move, flow or forced air through a conduit 9 to the intake manifold connected to the combustion engine or two a turbocharger system 10. The air delivery device 20 may be a displacement blower, a centrifugal compressor, scroll type compressor or other type of compressor.

The air delivery device 20 may include or may be driven by the electric motor 2 and may be utilized as a single or dual boost device operating alone or with a turbocharger system. By decoupling the air delivery device 20 from the engine 102 boost pressure can be immediately provide. This may avoid the non-optimum fueling required to reduce the lag time associated with a turbocharger and thereby may improve fuel economy. The electric motor 2 and the air delivery device 20 may be constructed and arranged to have near zero parasitic losses when boost is not needed and thus further improves fuel technology alternatives. A first power electronic module 3 may utilized to power and control the electric motor generator 1 and the electric motor 2. In a number of variations a second power electronic module 13 may be constructed and arranged to power and control the electric motors 2 and/or other components of the vehicle. In a number of variations the system may be constructed and arranged to operate with multiple voltages within a single housing. In a number of variations a higher voltage than 12V may be supplied to the electric motor 2 to increase efficiency and make components smaller. In a number of variations the components may be constructed and arranged to deliver both 12V and 48V power. The 48V power may be delivered to systems or components in the vehicle that can benefit from higher voltage without having to run entire vehicle electric systems at 48V. One or more short efficient electrical connection 4 may be provided between the power electric modules 3 and 13.

In a number of variations a scroll compressor may use two interleaving scrolls to pump, compress or pressurize fluids such as liquids and gases. The vane geometry may be involute, Archimedean spiral, or hybrid curves. One of the scrolls may be fixed, while the other orbits eccentrically without rotating, thereby trapping and pumping or compressing pockets of fluid between the scrolls. Another method for producing the compression motion is co-rotating the scrolls, in synchronous motion, but with offset centers of rotation. The relative motion is the same as if one were orbiting.

Another variation may include flexible (layflat) tubing where the archimedean spiral acts as a peristaltic pump, which operates on much the same principle as a toothpaste tube. They have casings filled with lubricant to prevent abrasion of the exterior of the pump tube and to aid in the dissipation of heat, and use reinforced tubes, often called ‘hoses’. This class of pump is often called a ‘hose pumper’. Furthermore, since there are no moving parts in contact with the fluid, peristaltic pumps are inexpensive to manufacture. Their lack of valves, seals and glands makes them comparatively inexpensive to maintain, and the use of a hose or tube makes for a low-cost maintenance item compared to other pump types.

A cooling system 108, such as cooling passages 5, which may include a water jacket, may be provided to cool the power electric modules 3, 13, the electric motor generator 1 and/or the electric motor 2. In a number of variations, a water cooling passage 5 may be include a portion which is common to the first power electric module 3 and the second power electric module 13 and may be interposed between the power electronics modules 3, 13. In a number of variations a single housing 6 may be provided and may include one or more of the electric motor generator 1, electric motor 2, first power electric module 3, second power electric module 13, and/or the air delivery device 20.

At least one energy storage device 7 may be provided dependent upon the application requirements. The energy storage device(s) 7 may be connected to the electric motor generator 1 to store electricity or the equivalent produced by the electric motor generator 1. The electric storage device 7 may be connected to the electric motor 2 to delivery electricity or power to drive the electric motors 2. A controller system 24 may be provided and connected to the electric motor generator 1, electric motor 2 and energy storage device 7 as well as other components of the vehicle which may be connected to the electric motor generator 1.

The controller system 24 may include main controller and/or a control subsystem may include one or more controllers (not separately shown) in communication with the components of the system 100 and/or other components of the vehicle for receiving and processing sensor input and transmitting output signals. The controller(s) may include one or more suitable processors and memory devices (not separately shown). The memory may be configured to provide storage of data and instructions that provide at least some of the functionality of the engine system and that may be executed by the processor(s). At least portions of the method may be enabled by one or more computer programs and various engine system data or instructions, energy stored device data, electric motor generator data and/or electric motor data stored in memory as look-up tables, formulas, algorithms, maps, models, or the like. In any case, the control subsystem may control engine system parameters or parameters of the system 100 by receiving input signals from the sensors, executing instructions or algorithms in light of sensor input signals, and transmitting suitable output signals to the various actuators, and/or components. As used herein, the term “model” may include any construct that represents something using variables, such as a look up table, map, formula, algorithm and/or the like. Models may be application specific and particular to the exact design and performance specifications of any given engine system or of the system 100.

The electric motor generator 1 can be utilized for start/stop operation of the combustion engine 102 as well as regenerative engine braking to produce fuel economy gains. For example, a belt-alternator-starter (BAS) use of the electric motor generator 1 to start the engine 102 which may be connected to the pulley 104 which is operatively connected to the electric motor generator 1. The product 100 may include electrical connections 8 such as wires for delivering 12V power to the electric system of the vehicle. Again, optionally, the system can deliver power other than 12V to the vehicle system components that can effectively use higher voltages such as, but not limited to, 24V, 48V.

The following description of variants is only illustrative of components, elements, acts, product and methods considered to be within the scope of the invention and are not in any way intended to limit such scope by what is specifically disclosed or not expressly set forth. The components, elements, acts, product and methods as described herein may be combined and rearranged other than as expressly described herein and still are considered to be within the scope of the invention.

Variation 1 may include a product comprising: an electric motor generator, a first power electronics module operatively connected to the electric motor generator; an electric motor constructed and arranged for driving an air delivery device, and a second power electronics module coupled to the electric motor.

Variation 2 may include a product as set forth in Variation 1 wherein the electric motor generator, first power electronics module, the electric motor, and the second power electronics module are contained within in a single housing.

Variation 3 may include a product as set forth in any of Variations 1-2 and further comprising a water jacket in the housing and constructed and arranged to cool the electric motor generator, first power electronics module, the electric motor, and the second power electronics module.

Variation 4 may include a product as set forth in any of Variations 1-3 wherein the water jacket includes a water passage interpose between the first power electronics module and the second power electronics module.

Variation 5 may include a product as set forth in any of Variations 1-4 and further comprising an energy storage device operatively connected to the electric motor generator to store energy produced by the electric motor generator, the energy storage device being operatively connected to supply energy to the electric motor.

Variation 6 may include a product as set forth in any of Variations 1-5 and further comprising a pulley operatively connected to the electric motor generator to drive the electric motor generator.

Variation 7 may include a product as set forth in any of Variations 1-6 and further comprising a combustion engine and a belt connected to the combustion engine, the engine being constructed and arranged to drive the belt and thereby drive the pulley.

Variation 8 may include a product as set forth in any of Variations 1-7 and further comprising a blower or compressor operatively connected to the electric motor to be driven thereby.

Variation 9 may include a product as set forth in Variation 8 further comprising an air conduit coupled to the blower or compressor so that the blower or compressor increases the pressure in the conduit.

Variation 10 may include a product as set forth in Variation 9 wherein the conduit is connected to the intake manifold of an engine.

Variation 11 may include a product as set forth in Variation 9 wherein the conduit is connected to a turbocharger.

Variation 12 may include a product as set forth in any of Variations 1-11 wherein the first electronic module is constructed and arranged to deliver 12V power to the electric motor generator.

Variation 13 may include a product as set forth in any of Variations 1-12 wherein the second power electric module is constructed and arranged to deliver 24V or 48V power.

Variation 14 may include a product as set forth in any of Variations 1-13 wherein the electric motor generator is constructed and arranged to produce regenerative power during engine braking.

Variation 15 may include a product as set forth in any of Variations 1-14 wherein the air deliver device comprises a displacement blower.

Variation 16 may include a product as set forth in any of Variations 1-15 wherein the air deliver device comprises a compressor.

Variation 17 may include a product as set forth in any of Variations 1-16 wherein the air deliver device comprises a centrifugal compressor.

Variation 18 may include a product as set forth in any of Variations 1-17 wherein the air deliver device comprises a scroll type compressor.

Variation 19 may include a product comprising: an electric motor generator for a vehicle and an electric motor constructed and arranged for driving an air delivery device, and single housing enclosing the electric motor generator and an electric motor.

Variation 20 may include a product as set forth in Variation 19 wherein the housing includes a water passage constructed and arranged so that fluid flowing through the water passages cools the electric motor generator and the electric motor.

The above description of select variations within the scope of the invention is merely illustrative in nature and, thus, variations or variants thereof are not to be regarded as a departure from the spirit and scope of the invention.

1. A product comprising:
an electric motor generator, a first power electronics module operatively connected to the electric motor generator;
an electric motor constructed and arranged for driving an air delivery device, and a second power electronics module coupled to the electric motor, wherein the electric motor generator, first power electronics module, the electric motor, and the second power electronics module are contained within in a single housing.

2. A product as set forth in claim 1 further comprising a cooling system connected to the housing.

3. A product comprising: an electric motor generator, a first power electronics module operatively connected to the electric motor generator;
an electric motor constructed and arranged for driving an air delivery device, and a second power electronics module coupled to the electric motor, wherein the electric motor generator, first power electronics module, the electric motor, and the second power electronics module are contained within a single housing, and further comprising a cooling jacket in the housing and constructed and arranged to cool the electric motor generator, first power electronics module, the electric motor, and the second power electronics module.

4. A product as set forth in claim 3 wherein the cooling jacket includes a water passage interpose between the first power electronics module and the second power electronics module.

5. A product as set forth in claim 1 further comprising an energy storage device operatively connected to the electric motor generator to store energy produced by the electric motor generator, the energy storage device being operatively connected to supply energy to the electric motor.

6. A product as set forth in claim 1 further comprising a pulley operatively connected to the electric motor generator to drive the electric motor generator.

7. A product as set forth in claim 6 further comprising a combustion engine and a belt connected to the combustion engine, the engine being constructed and arranged to drive the belt and thereby drive the pulley.

8. A product as set forth in claim 1 further comprising a blower or compressor operatively connected to the electric motor to be driven thereby.

9. A product as set forth in claim 8 further comprising an air conduit coupled to the blower or compressor so that the blower or compressor increases the pressure in the conduit.

10. A product as set forth in claim 9 wherein the conduit is connected to the intake manifold of an engine.

11. A product as set forth in claim 9 wherein the conduit is connected to a turbocharger.

12. A product as set forth in claim 1 wherein the first electronic module is constructed and arranged to deliver 12V power to the electric motor generator.

13. A product as set forth in claim 1 wherein the second power electric module is constructed and arranged to deliver 24V or 48V power.

14. A product as set forth in claim 1 wherein the electric motor generator is constructed and arranged to produce regenerative power during engine braking.

15. A product as set forth in claim 1 wherein the air deliver device comprises a displacement blower.

16. A product as set forth in claim 1 wherein the air deliver device comprises a compressor.

17. A product as set forth in claim 1 wherein the air deliver device comprises a centrifugal compressor.

18. A product as set forth in claim 1 wherein the air deliver device comprises a scroll type compressor.

19. A product comprising:
an electric motor generator for a vehicle and an electric motor constructed and arranged for driving an air delivery device, and single housing enclosing the electric motor generator and an electric motor, the electric motor generator and an electric motor being operatively connected together to supply energy to the electric motor.

20. A product comprising:
an electric motor generator for a vehicle and an electric motor constructed and arranged for driving an air delivery device, and single housing enclosing the electric motor generator and an electric motor, and wherein the housing includes a cooling passage constructed and arranged so that fluid flowing through the water passages cools the electric motor generator and the electric motor.

21. A product as set forth in 20 wherein the cooling passage is a water passage.

22. A product as set forth in 1 wherein the cooling jacket is a water cooling jacket.

23. A product as set forth in claim 19 wherein the electric motor generator and the electric motor are constructed and arranged to be decoupled.

24. A product comprising:
an electric motor generator, a first power electronics module operatively connected to the electric motor generator;
an electric motor constructed and arranged for driving an air delivery device, and a second power electronics module coupled to the electric motor, and a cooling system connected to the housing to cool at least one of the electric motor generator, the first power electronics module, the electric motor, or the second power electronics module.

25. A product as set forth in claim 24 wherein the cooling system includes cooling passage interposed between the first power electronics module and the second power electronics module.
